(19) United States
(12) Patent Application Publication
(10) Pub. No.: US 2010/0170124 A1
(43) Pub. Date: Jul. 8, 2010

(54) Advertisement With the Street Sign

(76) Inventor: Vladimir Chiltsov, Calabasas, CA (US)

Correspondence Address: Vera chernobylsky, 4623 Dunman Avenue, Woodland Hills, CA, 91364, US

(21) Appl. No.: 12/227,158

(22) PCT Filed: Jul. 12, 2008
(86) PCT No.: PCT/US2008/008519

§ 371 Date: Nov. 10, 2008

(51) Int. Cl. G09F 19/22

(52) U.S. Cl. 40/624

(57) ABSTRACT

Present invention relates generally to an advertisement on the roadway. In particular, it relates to an advertisement device located with the municipal street sign, positioned directly on the municipal street sign, in close proximity to a municipal street sign, or adjacent to a municipal street sign. Whenever street sign appears on the street, such as on a municipal light posts, on the cross streets, or a street sign on the municipal or privately owned building. The invention allows a vehicle driver to see the advertising simultaneously with the road sign without taking their attention off the road.

### TECHNICAL FIELD OF THE INVENTION

This present invention relates generally to an advertisement on the roadway. In particular, it relates to an advertisement device located with the municipal street sign, positioned directly on the municipal street sign, in close proximity to a municipal street sign, or adjacent to a municipal street sign. Whenever street sign appears on the street, such as on a municipal light posts, on the cross streets, or a street sign on the municipal or privately owned building. The invention allows a vehicle driver to see the advertising simultaneously with the road sign without taking their attention off the road.

### BACKGROUND OF THE INVENTION

Advertising signs are well known in the prior art. Further, the prior art has developed to such a point where sign compositions are developed to such stage where sign compositions are designed for particular applications like road signs, traffic information etc.

There is a constant need for municipalities to raise budgetary funds. This is might be achieved by selling advertising on municipally owned property. For example it is frequently accomplished with advertising on transit vehicles such as buses or trains. It is understood that municipality wants to increase its income.

Present invention offers another method of doing so as to create new streams of revenue by finding new locations in which to sell advertising space.

On the other hand, a lot of business establishments would desire to beneficially raise their business representation and redirect pedestrians and vehicle traffic into their stores.

Moreover, municipality themselves could use new spaces and opportunity for advertising.

In the case when driver of motor vehicle found himself driving down unfamiliar streets in the untried location trying to find a specific type of business establishment like specific store, restaurant, bank or pharmacy motor vehicle driver become frustrated by the confusion of the unfamiliar surroundings. Such situation creates by itself unsafe condition on the road for driver and adjoining drivers and pedestrians.

Unsafe driving operation of motor vehicle is common knowledge under unfamiliar circumstances while driving down unfamiliar location. Advertisement on the easy found street sign post of the driver's sought point of interest would elevate the burden on the driver in unfamiliar location and provide safer conditions on the street.

It is therefore desirable to provide new methods of advertising where drivers could safely find desirable establishment in unfamiliar location, simultaneously creating an additional source of revenue for municipality.

### SUMMARY OF THE INVENTION

This present invention relates generally to an advertisement on the roadway. In particular, it relates to an advertisement device located with the municipal street sign, positioned directly on the municipal street sign, in close proximity to a municipal street sign, or adjacent to a municipal street sign. Whenever street sign appears on the street, such as on a municipal light posts, on the cross streets, or a street sign on the municipal or privately owned building. The invention allows a vehicle driver to see the advertising simultaneously with the road sign without taking their attention off the road.

FIG. 1 illustrate first of the preferred embodiments—methods for installing or attaching an advertising sign with the street sign located on the municipal post.

The embodiment of the device 20 illustrated in FIG. 1 includes:

Advertisement sign 2, FIG. 1 is a commercial sign that can be of any size, shape or color desired by the advertiser. This sign must confirm to the local municipality's regulations. Sign 2 displays the name of the business, its trademark, or logo, such as McDonalds Golden Arches or Coca-Cola's familiar classical bottle. Further, advertising sign might show a promotional message, not connected to the particular business in the area.

FIG. 1 further depicts road sign 1 as a street sign that states the name of a cross street. Street sign is positioned on a municipal post having attached street light or/and street sign 11, FIG. 1. In other embodiments, the road sign can be any type of municipal sign, such as a parking sign, a direction sign, a warning sign, or other sign used to provide information to motorists while on the roadway. Sign 1 can be of any size, shape or color typical to the road sign. While FIG. 1 shows signs 1 and 2 to be of similar configurations and material, it is not necessary for sign 1 and sign 2 to be of the same design, shape, material or size.

The advertisement sign 2 is placed closely under the road sign 1. Signs 1 and 2 are adjacent to each other.

In one embodiment, advertisement sign 2 is attached to the road sign 1 by the chain type of the attachment as shown on FIG. 1. While FIG. 1 shows signs 1 and 2 to be attached to one another by the chain type of the connection, it is not necessary for sign 1 and sign 2 to be attached by the chain, the connection might be of any fastening devices known in the art that can be used to attach the advertisement and road signs.

Sign 1 and sign 2 might be attached with or without the space between the signs. Regardless, of whether they touch or not, the signs must be in close enough proximity such that a motorist driving can read both signs at approximately the same time.

FIG. 2 illustrate second of the preferred embodiments—methods for installing or attaching an advertising sign directly on the street sign located on the municipal post.

The embodiment of the device 30 illustrated in FIG. 2 includes:

1. Advertisement sign 4, FIG. 2 is a commercial sign that can be of any size, shape or color desired by the advertiser, but not covering the street name of the street sign. This sign must confirm to the local municipality's regulations. Sign 4 displays the name of the business, its trademark, or logo, such as McDonalds Golden Arches or Coca-Cola's familiar classical bottle. Further, advertising sign might show a promotional message, not connected to the particular business in the area.

FIG. 2 further depicts road sign 3 as a street sign that states the name of a cross street. Street sign is positioned on a municipal post having attached street light or/and street sign 12, FIG. 2. In other embodiments, the road sign can be any type of municipal sign, such as a parking sign, a direction sign, a warning sign, or other sign used to provide information to motorists while on the roadway. Sign 3 can be of any size, shape or color typical to the road sign. It is not necessary for sign 3 and sign 4 to be of the same design, shape, material or size.

The advertisement sign 4 is placed directly on the road sign 3. Signs 3 and 4 are attached to each other.

In one embodiment, advertisement sign 4 is attached to the road sign 3 by the any type of glue or any other adhesives available in the art as shown on FIG. 2. In another embodiment, advertisement sign 4 is attached to the road sign 3 by any type of screw or any other similar type of connection available in the art.

Sign 3 and sign 4 might be attached with or without the space between the signs. Regardless, of whether they touch or not, the signs must be in close enough proximity such that a motorist driving can read both signs at approximately the same time.

FIG. 3 illustrates another preferred embodiment—methods for installing or attaching an advertising sign with the street sign attached to the municipal post.

The embodiment of the device 40 illustrated in FIG. 3 includes:

Advertisement sign 6, FIG. 3 is a commercial sign that can be of any size, shape or color desired by the advertiser. This sign must confirm to the local municipality's regulations. Sign 6 displays the name of the business, its trademark, or logo, such as McDonalds Golden Arches or Coca-Cola's familiar classical bottle. Further, advertising sign might show a promotional message, not connected to the particular business in the area.

FIG. 3 further depicts road sign 5 as a street sign that states the name of a cross street. Street sign is positioned on a municipal post having attached street light or/and street sign 13, FIG. 3. In other embodiments, the road sign can be any type of municipal sign, such as a parking sign, a direction sign, a warning sign, or other sign used to provide information to motorists while on the roadway. Sign 5 can be of any size, shape or color typical to the road sign. While FIG. 3 shows signs 5 and 6 to be of similar configurations and material, it is not necessary for sign 3 and sign 6 to be of the same design, shape, material or size.

The advertisement sign 6 is placed closely under the road sign 5. Signs 5 and 6 are adjacent to each other.

In one embodiment, advertisement sign 6 is attached to the road sign 5 by the chain type of the attachment as shown on FIG. 3. While FIG. 3 shows signs 5 and 6 to be attached to one another by the chain type of the connection, it is not necessary for sign 5 and sign 6 to be attached by the chain, the connection might be of any fastening devices known in the art that can be used to attach the advertisement and road signs.

Sign 5 and sign 6 might be attached with or without the space between the signs. Regardless, of whether they touch or not, the signs must be in close enough proximity such that a motorist driving can read both signs at approximately the same time.

FIG. 4 illustrates another preferred embodiment—methods for installing or attaching an advertising sign directly on the street sign located with the municipal post.

The embodiment of the device 50 illustrated in FIG. 4 includes:

1. Advertisement sign 8, FIG. 4 is a commercial sign that can be of any size, shape or color desired by the advertiser, but not covering the street name of the street sign. This sign must confirm to the local municipality's regulations. Sign 8 displays the name of the business, its trademark, or logo, such as McDonalds Golden Arches or Coca-Cola's familiar classical bottle. Further, advertising sign might show a promotional message, not connected to the particular business in the area.

FIG. 4 further depicts road sign 7 as a street sign that states the name of a cross street. Street sign is positioned on a municipal post having attached street light or/and street sign 14, FIG. 4. In other embodiments, the road sign can be any type of municipal sign, such as a parking sign, a direction sign, a warning sign, or other sign used to provide information to motorists while on the roadway. Sign 7 can be of any size, shape or color typical to the road sign. It is not necessary for sign 7 and sign 8 to be of the same design, shape, material or size.

The advertisement sign 8 is placed directly on the road sign 7. Signs 7 and 8 are attached to each other.

In one embodiment, advertisement sign 8 is attached to the road sign 7 by the any type of glue or any other adhesives available in the art as shown on FIG. 4. In another embodiment, advertisement sign 8 is attached to the road sign 7 by any type of screw or any other similar type of connection available in the art.

Sign 7 and sign 8 might be attached with or without the space between the signs. Regardless, of whether they touch or not, the signs must be in close enough proximity such that a motorist driving can read both signs at approximately the same time.

FIG. 5 illustrates another preferred embodiment—methods for installing or attaching an advertising sign with the municipal street sign attached to the municipally or privately owned building.

The embodiment of the device 60 illustrated in FIG. 5 includes:

Advertisement sign 10, FIG. 5 is a commercial sign that can be of any size, shape or color desired by the advertiser. This sign must confirm to the local municipality's regulations. Sign 10 displays the name of the business, its trademark, or logo, such as McDonalds Golden Arches or Coca-Cola's familiar classical bottle. Further, advertising sign might show a promotional message, not connected to the particular business in the area.

FIG. 5 further depicts road sign 9 as a street sign that states the name of a street. Municipal street sign is positioned on a municipally or privately owned building having attached street sign 15, FIG. 5. Sign 9 can be of any size, shape or color typical to the road sign. While FIG. 5 shows signs 9 and 10 to be of similar configurations and material, it is not necessary for sign 9 and sign 10 to be of the same design, shape, material or size.

The advertisement sign 10 is placed closely under the street sign 9. Signs 9 and 10 are adjacent to each other.

In one embodiment, advertisement sign 10 is attached to the street sign 9 by the chain type of the attachment. It is not necessary for sign 9 and sign 10 to be attached by the chain, the connection might be of any fastening devices known in the art that can be used to attach the advertisement and road signs.

Sign 9 and sign 10 might be attached with or without the space between the signs. Regardless, of whether they touch or not, the signs must be in close enough proximity such that a motorist driving can read both signs at approximately the same time.

### BRIEF DESCRIPTION OF THE DRAWINGS

FIG. 1 depicts a perspective view of the first embodiment of the advertisement sign attached to the street sign: 1—street sign; 2—advertisement sign, logo, or trademark; 11—municipal post having attached street light or/and street sign; 20—a combination of a street and advertisement sign in accordance with the first embodiment of the invention.

FIG. 2 depicts perspective view of the second embodiment of the advertisement sign placed directly on top of a street sign: 3—street sign; 4—advertisement sign, logo, or trademark; 12—municipal post having attached street light or/and street sign; 30—a combination of a street and advertisement sign in accordance with the second embodiment of the invention.

FIG. 3 depicts perspective view of another embodiment of the advertisement sign placed directly on top of a street sign: 5—street sign; 6—advertisement sign, logo, or trademark; 13—municipal post having attached street light or/and street sign; 40—a combination of a street and advertisement sign in accordance with this embodiment of the invention.

FIG. 4 depicts perspective view of another embodiment of the advertisement sign placed directly on top of a street sign: 7—street sign; 8—advertisement sign, logo, or trademark; 14—municipal post having attached street light or/and street sign; 50—a combination of a street and advertisement sign in accordance with this embodiment of the invention.

FIG. 5 depicts a perspective view of another embodiment of the advertisement sign attached to the street sign: 9—street sign; 10—advertisement sign, logo, or trademark; 15—municipally or privately owned building having attached municipally owned street sign; 60—a combination of a street and advertisement sign in accordance with this embodiment of the invention.

### DETAILED DESCRIPTION OF THE PREFERRED EMBODIMENTS

This present invention relates generally to an advertisement on the roadway. In particular, it relates to an advertisement device located with the municipal street sign, positioned directly on the municipal street sign, in close proximity to a municipal street sign, or adjacent to a municipal street sign. Whenever street sign appears on the street, such as on a municipal light posts, on the cross streets, or a street sign on the municipal or privately owned building. The invention allows a vehicle driver to see the advertising simultaneously with the road sign without taking their attention off the road.

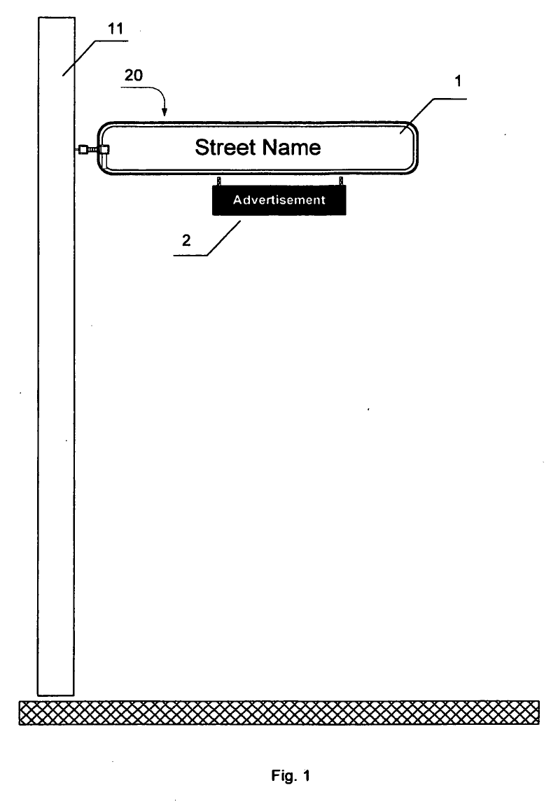

FIG. 1 illustrate first of the preferred embodiments—methods for installing or attaching an advertising sign with the street sign located on the municipal post.

The embodiment of the device 20 illustrated in FIG. 1 includes:

Advertisement sign 2, FIG. 1 is a commercial sign that can be of any size, shape or color desired by the advertiser. This sign must confirm to the local municipality's regulations. Sign 2 displays the name of the business, its trademark, or logo, such as McDonalds Golden Arches or Coca-Cola's familiar classical bottle. Further, advertising sign might show a promotional message, not connected to the particular business in the area.

FIG. 1 further depicts road sign 1 as a street sign that states the name of a cross street. Street sign is positioned on a municipal post having attached street light or/and street sign 11, FIG. 1. In other embodiments, the road sign can be any type of municipal sign, such as a parking sign, a direction sign, a warning sign, or other sign used to provide information to motorists while on the roadway. Sign 1 can be of any size, shape or color typical to the road sign. While FIG. 1 shows signs 1 and 2 to be of similar configurations and material, it is not necessary for sign 1 and sign 2 to be of the same design, shape, material or size.

The advertisement sign 2 is placed closely under the road sign 1. Signs 1 and 2 are adjacent to each other.

In one embodiment, advertisement sign 2 is attached to the road sign 1 by the chain type of the attachment as shown on FIG. 1. While FIG. 1 shows signs 1 and 2 to be attached to one another by the chain type of the connection, it is not necessary for sign 1 and sign 2 to be attached by the chain, the connection might be of any fastening devices known in the art that can be used to attach the advertisement and road signs.

Sign 1 and sign 2 might be attached with or without the space between the signs. Regardless, of whether they touch or not, the signs must be in close enough proximity such that a motorist driving can read both signs at approximately the same time.

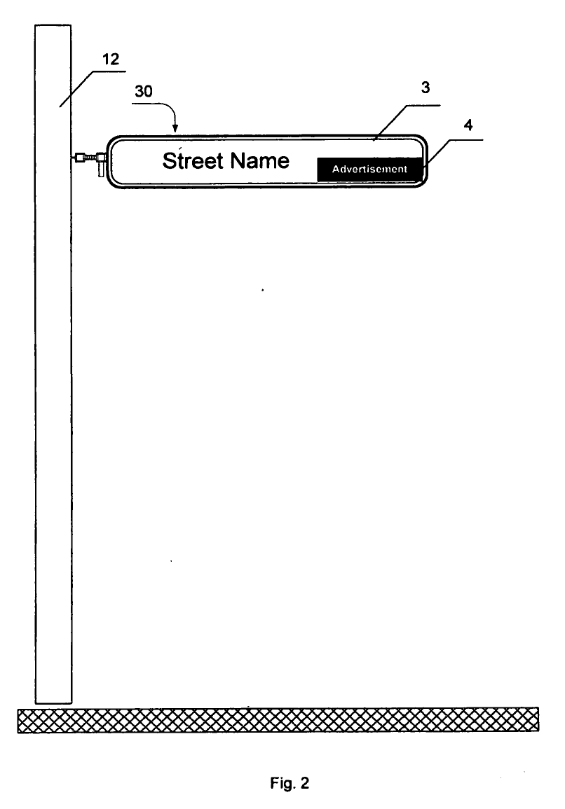

FIG. 2 illustrate second of the preferred embodiments—methods for installing or attaching an advertising sign directly on the street sign located on the municipal post.

The embodiment of the device 30 illustrated in FIG. 2 includes:

1. Advertisement sign 4, FIG. 2 is a commercial sign that can be of any size, shape or color desired by the advertiser, but not covering the street name of the street sign. This sign must confirm to the local municipality's regulations. Sign 4 displays the name of the business, its trademark, or logo, such as McDonalds Golden Arches or Coca-Cola's familiar classical bottle. Further, advertising sign might show a promotional message, not connected to the particular business in the area.

FIG. 2 further depicts road sign 3 as a street sign that states the name of a cross street. Street sign is positioned on a municipal post having attached street light or/and street sign 12, FIG. 2. In other embodiments, the road sign can be any type of municipal sign, such as a parking sign, a direction sign, a warning sign, or other sign used to provide information to motorists while on the roadway. Sign 3 can be of any size, shape or color typical to the road sign. It is not necessary for sign 3 and sign 4 to be of the same design, shape, material or size.

The advertisement sign 4 is placed directly on the road sign 3. Signs 3 and 4 are attached to each other.

In one embodiment, advertisement sign 4 is attached to the road sign 3 by the any type of glue or any other adhesives available in the art as shown on FIG. 2. In another embodiment, advertisement sign 4 is attached to the road sign 3 by any type of screw or any other similar type of connection available in the art.

Sign 3 and sign 4 might be attached with or without the space between the signs. Regardless, of whether they touch or not, the signs must be in close enough proximity such that a motorist driving can read both signs at approximately the same time.

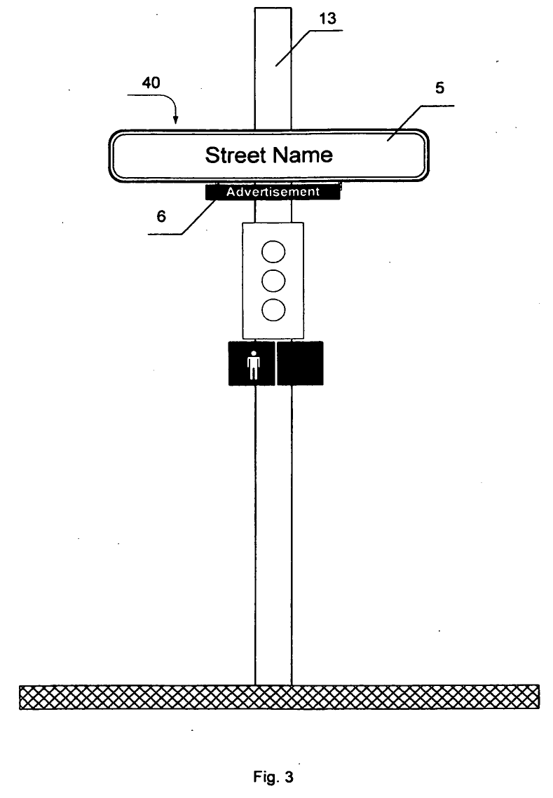

FIG. 3 illustrate third of the preferred embodiments—methods for installing or attaching an advertising sign with the street sign located on the municipal post.

The embodiment of the device 40 illustrated in FIG. 3 includes:

Advertisement sign 6, FIG. 3 is a commercial sign that can be of any size, shape or color desired by the advertiser. This sign must confirm to the local municipality's regulations. Sign 6 displays the name of the business, its trademark, or logo, such as McDonalds Golden Arches or Coca-Cola's familiar classical bottle. Further, advertising sign might show a promotional message, not connected to the particular business in the area.

FIG. 3 further depicts road sign 5 as a street sign that states the name of a cross street. Street sign is positioned on a municipal post having attached street light or/and street sign 13, FIG. 3. In other embodiments, the road sign can be any type of municipal sign, such as a parking sign, a direction sign, a warning sign, or other sign used to provide information to motorists while on the roadway. Sign 5 can be of any size, shape or color typical to the road sign. While FIG. 3 shows signs 5 and 6 to be of similar configurations and material, it is not necessary for sign 3 and sign 6 to be of the same design, shape, material or size.

The advertisement sign 6 is placed closely under the road sign 5. Signs 5 and 6 are adjacent to each other.

In one embodiment, advertisement sign 6 is attached to the road sign 5 by the chain type of the attachment as shown on FIG. 3. While FIG. 3 shows signs 5 and 6 to be attached to one another by the chain type of the connection, it is not necessary for sign 5 and sign 6 to be attached by the chain, the connection might be of any fastening devices known in the art that can be used to attach the advertisement and road signs.

Sign 5 and sign 6 might be attached with or without the space between the signs. Regardless, of whether they touch or not, the signs must be in close enough proximity such that a motorist driving can read both signs at approximately the same time.

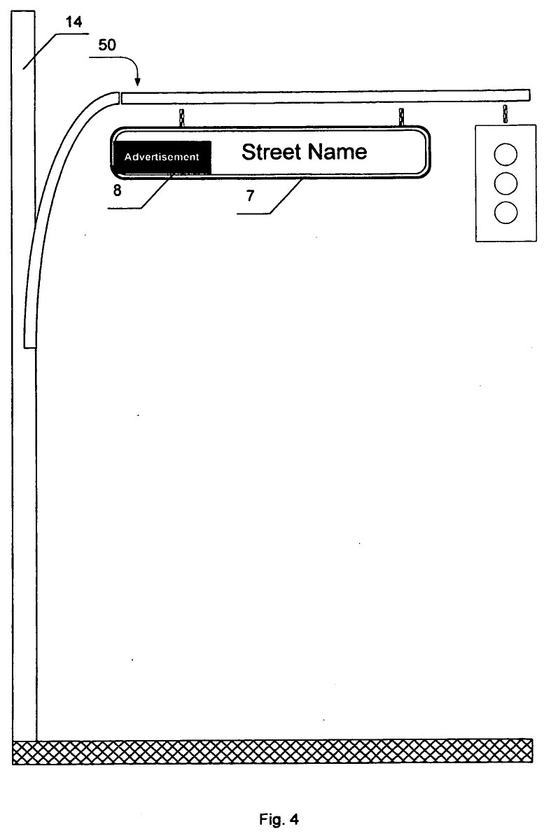

FIG. 4 illustrates another preferred embodiment—methods for installing or attaching an advertising sign directly on the street sign located with the municipal post.

The embodiment of the device 50 illustrated in FIG. 4 includes:

1. Advertisement sign 8, FIG. 4 is a commercial sign that can be of any size, shape or color desired by the advertiser, but not covering the street name of the street sign. This sign must confirm to the local municipality's regulations. Sign 8 displays the name of the business, its trademark, or logo, such as McDonalds Golden Arches or Coca-Cola's familiar classical bottle. Further, advertising sign might show a promotional message, not connected to the particular business in the area.

FIG. 4 further depicts road sign 7 as a street sign that states the name of a cross street. Street sign is positioned on a municipal post having attached street light or/and street sign 14, FIG. 4. In other embodiments, the road sign can be any type of municipal sign, such as a parking sign, a direction sign, a warning sign, or other sign used to provide information to motorists while on the roadway. Sign 7 can be of any size, shape or color typical to the road sign. It is not necessary for sign 7 and sign 8 to be of the same design, shape, material or size.

The advertisement sign 8 is placed directly on the road sign 7. Signs 7 and 8 are attached to each other.

In one embodiment, advertisement sign 8 is attached to the road sign 7 by the any type of glue or any other adhesives available in the art as shown on FIG. 4. In another embodiment, advertisement sign 8 is attached to the road sign 7 by any type of screw or any other similar type of connection available in the art.

Sign 7 and sign 8 might be attached with or without the space between the signs. Regardless, of whether they touch or not, the signs must be in close enough proximity such that a motorist driving can read both signs at approximately the same time.

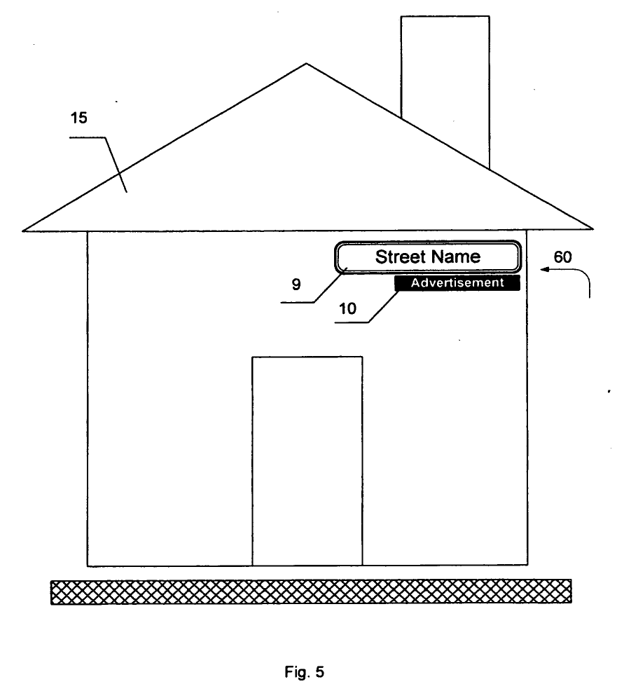

FIG. 5 illustrates another preferred embodiment—methods for installing or attaching an advertising sign with the municipal street sign attached to the municipally or privately owned building.

The embodiment of the device 60 illustrated in FIG. 5 includes:

Advertisement sign 10, FIG. 5 is a commercial sign that can be of any size, shape or color desired by the advertiser. This sign must confirm to the local municipality's regulations. Sign 10 displays the name of the business, its trademark, or logo, such as McDonalds Golden Arches or Coca-Cola's familiar classical bottle. Further, advertising sign might show a promotional message, not connected to the particular business in the area.

FIG. 5 further depicts road sign 9 as a street sign that states the name of a street. Municipal street sign is positioned on a municipally or privately owned building having attached street sign 15, FIG. 5. Sign 9 can be of any size, shape or color typical to the road sign. While FIG. 5 shows signs 9 and 10 to be of similar configurations and material, it is not necessary for sign 9 and sign 10 to be of the same design, shape, material or size.

The advertisement sign 10 is placed closely under the street sign 9. Signs 9 and 10 are adjacent to each other.

In one embodiment, advertisement sign 10 is attached to the street sign 9 by the chain type of the attachment. It is not necessary for sign 9 and sign 10 to be attached by the chain, the connection might be of any fastening devices known in the art that can be used to attach the advertisement and road signs.

Sign 9 and sign 10 might be attached with or without the space between the signs. Regardless, of whether they touch or not, the signs must be in close enough proximity such that a motorist driving can read both signs at approximately the same time.

What is claimed is:

1: A method for advertising comprising the steps of:
placing or attaching an advertisement sign adjacent to a municipally owned road/street sign, forming a combination sign, wherein both the road/street sign and the advertisement sign are placed on the municipal post and viewable in course of driving by motorist/drivers.

2: A method for advertising comprising the steps of:
placing or attaching an advertisement sign directly on a municipally owned road/street sign, forming a combination sign, wherein both the road/street sign and the advertisement sign are placed on the municipal post and viewable in course of driving by motorist/drivers.

3: A method for advertising comprising the steps of:
placing or attaching an advertisement sign adjacent to a municipally own road/street sign positioned on the municipally or privately owned building, forming a combination sign, wherein both the road/street sign and the advertisement sign are placed on the municipally or privately owned building and viewable in course of driving by motorist/drivers.
